(19) United States
(12) Patent Application Publication
(10) Pub. No.: US 2004/0165972 A1
(43) Pub. Date: Aug. 26, 2004

(54) Apparatus and method for insertion of a sample into a vacuum chamber

(76) Inventor: Vladimir Knyazik, Palo Alto, CA (US)

Correspondence Address: VLADIMIR KNYAZIK, 1036 COLORADO AVE #2J, PALO ALTO, CA, 94303, US

(21) Appl. No.: 10/371,952

(22) Filed: Feb. 21, 2003

(51) Int. Cl. F17B 1/00

(52) U.S. Cl. 414/217

(57) ABSTRACT

An apparatus of the invention comprises a tube with a vacuum chamber located in its middle portion and a rod inserted in the tube so that the gap between the rod and inner surface of the tube is narrow, e.g. within the range from 5 to 10 microns. Compressed air is injected to the gap between the inner surface of the tube and the rod via orifices at the ends of the tube to form air bearings, which allow moving the rod along its axis. A sample is placed in a recess in the rod, so that it can be inserted from the ambient atmosphere into the vacuum chamber by moving the rod along its axis. Since the gap between the rod and inner surface of the tube is narrow, the air leakage to vacuum chamber is insignificant. This leakage can be further decreased by evacuating an excess air from the gap in one or more areas between the vacuum chamber and orifices.

### CROSS-REFERENCE TO RELATED APPLICATIONS

Not Applicable

### FEDERALLY SPONSORED RESEARCH

Not Applicable

### SEQUENCE LISTING OR PROGRAMM

Not Applicable

### FIELD OF INVENTION

The present invention relates to the field of vacuum technology, in particular to the systems, which require insertion of a sample into a high vacuum region. The invention may find application in many fields where reduction of the time required for insertion of a sample into a vacuum system can affect the overall throughput of the equipment.

### BACKGROUND OF THE INVENTION

There are a lot of various technological procedures performed under vacuum. The examples are sputtering, etching, electron microscopy, mass spectrometry. Two standard approaches are typically used to insert a sample from atmosphere into a vacuum chamber. The first most obvious approach consists of filling the chamber with air up to atmospheric pressure prior to sample insertion. Then the chamber with the sample can be evacuated to the required degree of vacuum. Depending on chamber size and depth of vacuum, evacuating the chamber can take a significant amount of time and affect the overall throughput of the equipment. According to the second approach, the equipment throughput can be improved if the sample is evacuated in an airlock chamber attached to the main vacuum chamber (see U.S. Pat. No. 5,354,380 to Zejda, 1994). Then the sample can be moved from the airlock chamber to the main chamber under vacuum. This approach eliminates waste of time for evacuating the main chamber, but requires additional complicated equipment, i.e. airlock chamber and means to manipulate with a sample under vacuum.

A static air bearing is a well-known device, which allows rotational or linear motion practically without friction. It is widely used for precision positioning, high-speed rotation, in test equipment, etc. A feature of static air bearing is that to ensure high stiffness and load capacity the gap between its stationary and moving parts must be narrow (typically 5 to 10 microns). This feature allows using air bearing to transmit a motion into a vacuum chamber, so that the air bearing gap additionally works as a vacuum seal (see U.S. Pat. No. 4,118,042 to Booth, 1978).

### SUMMARY

An apparatus of the invention comprises a tube with a vacuum chamber located in its middle portion and a rod inserted in the tube so that the gap between the rod and inner surface of the tube is narrow, e.g. within the range from 5 to 10 microns. Compressed air is injected to the gap between the inner surface of the tube and the rod via orifices at the ends of the tube to form air bearings, which allow moving the rod along its axis. A sample is placed in a recess in the rod, so that it can be inserted from the ambient atmosphere into the vacuum chamber by moving the rod along its axis. Since the gap between the rod and inner surface of the tube is narrow, the air leakage to vacuum chamber is insignificant. This leakage can be further decreased by evacuating an excess air from the gap in one or more areas between the vacuum chamber and orifices.

It is an object of the invention to provide a simple apparatus for insertion of a sample into a vacuum chamber.

Another object of the invention is to minimize the time required for insertion of a sample into a vacuum chamber.

Additional object of the invention is to allow insertion of one sample into a vacuum chamber simultaneously with removing another sample from the vacuum chamber.

One more object of the invention is to provide an apparatus for insertion of a sample into a vacuum chamber which is easy to operate.

### BRIEF DESCRIPTION OF THE DRAWINGS

FIG. 1A and FIG. 1B show a preferred embodiment of the apparatus of the invention with a sample outside the apparatus and inside the vacuum chamber, respectively.

FIG. 2 shows arrangement of orifices in the preferred embodiment of the apparatus of the invention with no orifice on top side of the tube, which allows recess on the rod to pass through this region between the orifices.

FIG. 3 shows the first alternative embodiment of the apparatus of the invention with additional grooves between the orifices, which allow recess on the rod to remain under atmospheric pressure while passing through the region of orifices.

FIG. 4 shows the second alternative embodiment of the apparatus of the invention with an additional recess on the opposite side of the rod, preventing asymmetrical pressure distribution when the recess with a sample is at the orifices.

FIG. 5 shows the third alternative embodiment of the apparatus of the invention with an annular groove on the rod, preventing asymmetrical pressure distribution when the recess with a sample is at the orifices.

FIG. 6A and FIG. 6B respectively show two working positions of the rod in apparatus of another embodiment on which one sample can be inserted into the vacuum chamber simultaneously with removal of another sample.

### DETAILED DESCRIPTION

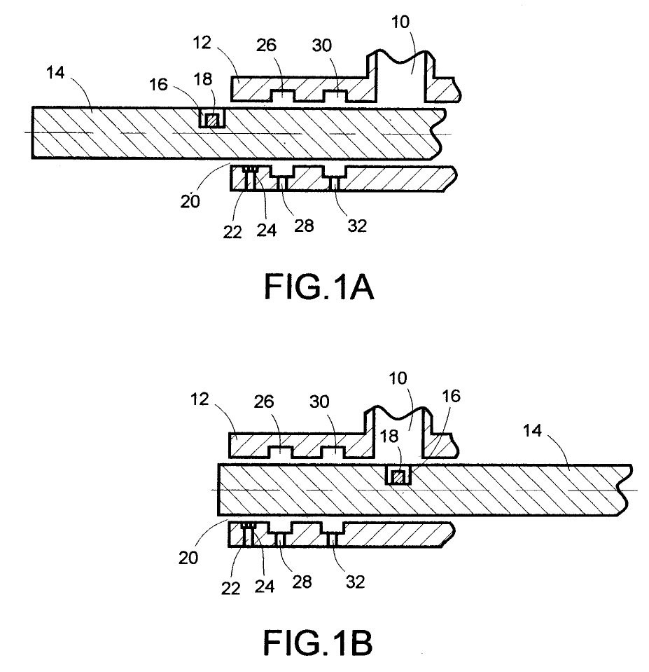

FIG. 1A and FIG. 1B show a preferred embodiment of the apparatus of the invention with a sample outside the apparatus and inside the vacuum chamber, respectively. The apparatus consists of a vacuum chamber 10 intersected by a tube 12 with precision inner diameter and a precision rod 14. The diameter of rod 14 can be, e.g., 30 mm. The rod has a recess 16 which contains a sample 18. The length, width, and depth of recess 16 can be, e.g., 10 mm×10 mm×10 mm. The construction of the apparatus of the invention is symmetrical with respect to vacuum chamber 10. For the sake of simplicity we will describe all the features of the apparatus on one side from vacuum chamber 10. It is understood that for each of the described features there is a similar feature on the opposite side from vacuum chamber 10.

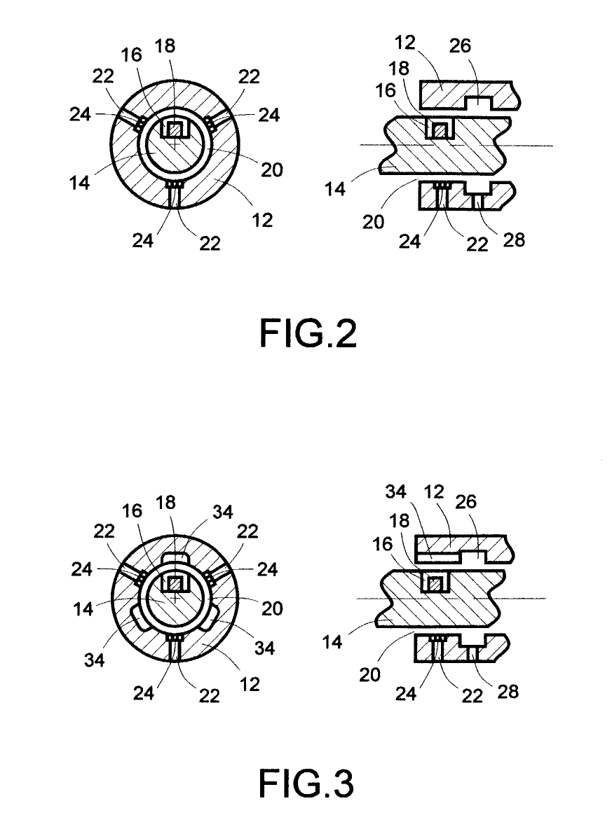

A narrow gap 20 between the inner surface of tube 12 and rod 14 is connected to a source of compressed air (not shown) via passages 22 and orifices 24 in proximity to the end of tube 12. The thickness of gap 20 can be, e.g., 10 microns. The diameters of orifices 24 can be, e.g., 0.1 mm and their number can be, e.g., 3. FIG. 2 shows arrangement of orifices 24 in the preferred embodiment of the apparatus of the invention with no orifice on top side of tube 12.

There is an annular groove 26 on the inner surface of tube 12 between orifices 24 and vacuum chamber 10 (FIG. 1A,B). This groove is connected to ambient atmosphere by a passage 28. There is an annular groove 30 on the inner surface of tube 12 between groove 26 and vacuum chamber 10. This groove is connected to a vacuum pump (not shown) by a passage 32. The distances between grooves 26, 30, and vacuum chamber 10 can be, e.g., 20 mm.

An apparatus of the invention operates in the following manner. Initial position of rod 14 (FIG. 1A) provides that recess 16 is outside tube 12 so that sample 18 can be placed into recess 16. Compressed air at a pressure, e.g., of about five atmospheres is injected into gap 20 via passages 22 and orifices 24 and escapes from gap 20 to groove 26 and to the ambient atmosphere at the end of tube 12. By flowing through gap 20, compressed air detaches rod 14 from the inner wall of tube 12 to form an air bearing, which allows moving rod 14 inside tube 12. From groove 26 air escapes to the ambient atmosphere via passage 28, so that pressure in groove 26 remains equal to the atmospheric pressure.

Gap 20 serves as an air bearing between the end of tube 12 and groove 26. In view of its minimal thickness, the same gap 20 between groove 26 and chamber 10 serves as a vacuum seal. In order to decrease air leakage from the ambient atmosphere to vacuum chamber 10, groove 30 is evacuated via passage 32. Residual pressure in groove 30 can be, e.g., 100 Pa. Residual pressure in vacuum chamber 10 can be, e.g., 0.01 Pa.

Air leakage through gap 20 occurs in viscous flow regime when the mean free pass of molecules is less than the gap thickness. Otherwise, air leakage occurs in molecular flow regime. For the gap thickness of 10 microns transition from viscous to molecular flow regime occurs at a pressure of about 10⁴ Pa. Thus, between groove 26 and groove 30 air leakage occurs mainly in viscous regime. Between groove 30 and vacuum chamber 10 air leakage occurs solely in molecular regime. Taking into account the regime of air flow in each region, the following estimations of leakages can be made:

from groove 26 to groove 30 leakage is about 1 l/s at 100 Pa,

from groove 30 to vacuum chamber 10 leakage is about 1 l/s at 0.01 Pa.

Leakages of these levels can be easily evacuated by conventional vacuum pumps.

To insert sample 18 into vacuum chamber 10, one can move rod 14 along its axis from position shown on FIG. 1A, where recess 16 with sample 18 is outside tube 12, to the position shown in FIG. 1B, where recess 16 with sample 18 is inside vacuum chamber 10. The above described air bearing allows to perform this motion easily. On its way to vacuum chamber 10, recess 16 with sample 18 passes through the region of elevated pressure at orifices 24, then through the region of atmospheric pressure at groove 26, and the region of intermediate vacuum at groove 30. When sample 18 is inside vacuum chamber 10 (FIG. 1B), its position can be adjusted along the axis of tube 12 by shifting rod 14 in the axial direction and across the axis of tube 12 by pivoting rod 14 around its axis. Both of these motions are made possible due to the use of the air bearing.

Being in proximity of orifices 24, recess 16 can affect air flow and pressure in gap 20. As a result, rod 14 can be shifted from the axis of tube 12. To minimize distortion of pressure field in gap 20, orifices 24 are distributed around the axis of tube 12 in such a way that recess 16 can pass though this region between the orifices (FIG. 2). As the distortion of pressure field in gap 20 is small, rod 14 does not touch the inner surface of tube 12 and can continue its axial motion.

Pressure in recess 16 with sample 18 takes the value of atmospheric pressure when the recess passes through the region of groove 26. Region of groove 30 serves as an intermediate vacuum chamber. Passing through this region, recess 16 with sample 18 is evacuated to an intermediate degree of vacuum. Performance of the pump attached to groove 30 must be high enough to evacuate recess 16 while it passes the groove. For example, if rod 14 moves with a speed of 1 cm/s, performance of the pump attached to groove 30 can be 10 l/s at 100 Pa.

There are several alternative possibilities to deal with distortion of pressure field in gap 20 when recess 16 is at orifices 24. In the description of preferred embodiment of the invention this pressure distortion is minimized by proper distribution of orifices 24 around the axis of tube 12 (FIG. 2). As shown in FIG. 3, the distortion of pressure field can be completely avoided with the help of additional grooves 34 on the inner surface of tube 12 along its axis between orifices 24. Grooves 34 connect groove 26 with the end of tube 12, so that one of grooves 34 is aligned with the pass of recess 16 and provide that recess 16 with sample 18 remains under atmospheric pressure while passing through the region of orifices 24.

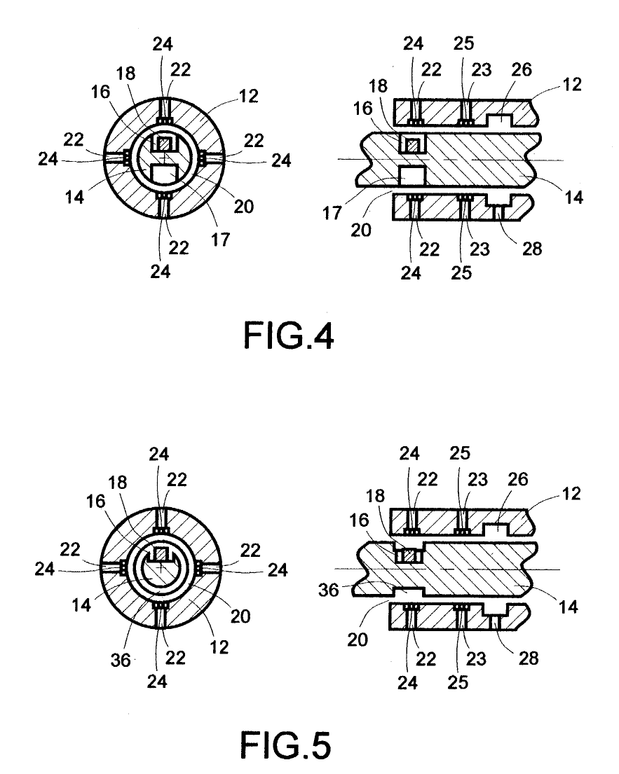

Another possibility to let the recess 16 pass through the region of orifices 24 freely is to keep pressure distribution in gap 20 symmetrical, so that no net radial force on rod 14 would arise. It can be done by supplementing recess 16 on the top side of rod 14 with an extra recess 17 of the same size as recess 16 on the bottom side of rod 14. FIG. 4 shows the embodiment of the apparatus of the invention with recess 17. Distribution of orifices 24 around the axis of tube 12 in this case must be symmetrical with respect to the horizontal plane passing through the axis of tube 12. The ability of airflow from orifices 24 to support rod 14 in this position vanishes. To keep rod 14 at this position afloat, additional flow of compressed air is injected into gap 20 via passages 23 and orifices 25 located between orifices 24 and groove 26.

When recess 16 passes orifices 25, rod 14 is supported by compressed air injected via orifices 24. As shown in FIG. 5, asymmetrical pressure distribution in gap 20 can also be eliminated with a help of an annular groove 36 on rod 14 overlapping with recess 16. In this case additional orifices 25 should also be installed to keep rod 14 afloat when recess 16 passes orifices 24.

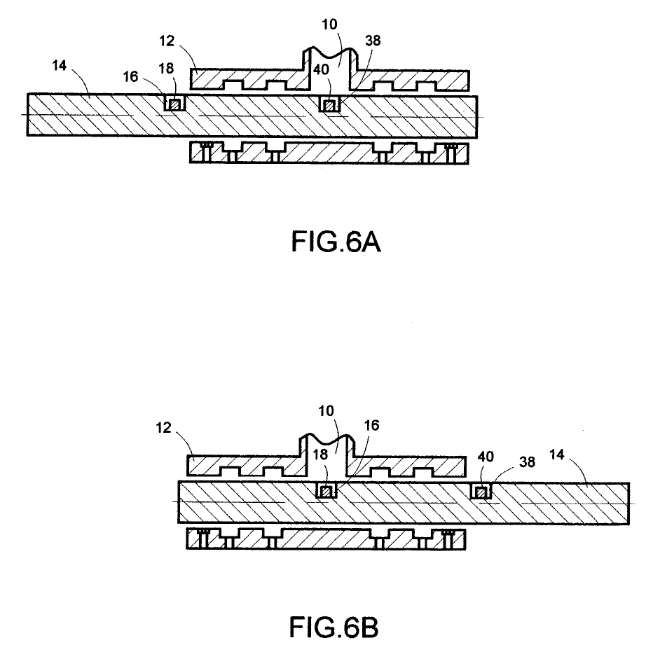

An additional embodiment of the apparatus of the invention is shown in FIG. 6A and FIG. 6B. The device of this embodiment allows insertion of one sample into vacuum chamber 10 simultaneously with removing of another sample. This goal is achieved with the help of an additional recess 38 on rod 14. The proper distance between recesses 16 and 38 provides that recess 16 is outside tube 12 when recess 38 is inside vacuum chamber 10 (FIG. 6A) and vice versa (FIG. 6B). Thus, when sample 18 in recess 16 is inserted into vacuum chamber 10, sample 40 in recess 38 is removed from vacuum chamber 10.

On its way to vacuum chamber 10, recess 16 with sample 18 must be evacuated at groove 30 to the intermediate vacuum level. At a given performance of a pump, attached to groove 30, evacuating recess 16 with sample 18 takes a certain time. To speed up insertion of sample 18 into vacuum chamber 10, one or both of two alternative means can be used. Namely, rod 14 can be moved non-uniformly, so that recess 16 with sample 18 moves fast before and after groove 30, but stays for a certain time at groove 30 until pressure in recess 16 is decreased to the proper level. Alternatively, buffer chamber can be attached to groove 30. In this case, pressure in recess 16 will instantly equalize with pressure in the buffer chamber when the recess is at groove 30. If the volume of buffer chamber is high enough, common pressure of the buffer chamber and recess 16 will be close to initial pressure of buffer chamber.

Thus it has been shown that the invention provides apparatus and method that simplify insertion of a sample into a vacuum chamber, minimize the time required for insertion of a sample into a vacuum chamber, and allow insertion of one sample into a vacuum chamber simultaneously with removing another sample from the vacuum chamber.

Although the invention has been shown and described with reference to specific embodiments, it is understood that these embodiments should not be construed as limiting the areas of application of the invention and that any changes and modifications are possible, provided these changes and modifications do not depart from the scope of the attached patent claims. For example, although only one groove 30 was shown as an intermediate vacuum chamber, it is understood, that number of these grooves, distances between adjacent grooves, and residual pressures in the grooves are determined by the requirements to vacuum depth and by leakage allowed to vacuum chamber 10. If requirements to vacuum and leakage in chamber 10 are minimal, the apparatus can be made even without groove 30 and/or without groove 26. Otherwise, the number of grooves 30 can be one or more. Each subsequent groove on the way of recess 16 with sample 18 to vacuum chamber 10 is evacuated to the increasingly deep vacuum. The groove adjacent to vacuum chamber 10 can be evacuated to the same vacuum degree as vacuum chamber 10. In this case there will be no leakage to vacuum chamber 10 from gap 20, and no pressure spike in vacuum chamber 10 during insertion of sample 18.

1. An apparatus for insertion of a sample into a vacuum chamber comprising:
a housing located in a surrounding atmosphere and having one side, a side opposite to said one side, and a through opening passing from said one side to said side opposite to said one side;
said vacuum chamber sealingly connected to said through opening at a connection point between said one side and said side opposite to said one side;
a moveable member having a first end projecting from said housing through said one side and a second end projecting from said housing through said side opposite to said one side, said moveable member being slidingly inserted into said through opening for performing a reciprocating sliding motion;
static gas bearings formed between said through opening and said moveable member on both sides of said through opening from said connection point, said static gas bearings having a predetermined gap between said opening and said moveable member, and means for supplying compressed gas into said predetermined gap;
at least one sample accommodation recess formed on said moveable member in a location that can alternatingly either protrude from said housing or reach said vacuum chamber during said reciprocating sliding motion.

2. The apparatus of claim 1, wherein said through opening has first annular recesses between said connection point and said static gas bearings, said first annular recesses being connected to said surrounding atmosphere for exhausting said gas from said static gas bearings.

3. The apparatus of claim 1, wherein said through opening has second annular recesses between said connection point and said static gas bearings, said second annular recesses being connected to at least one vacuum pump.

4. The apparatus of claim 2, wherein said through opening has second annular recesses between said connection point and said first annular recesses, said second annular recesses being connected to at least one vacuum pump.

5. The apparatus of claim 1, wherein said predetermined gap operates as a seal between said static gas bearings and said connection point.

6. The apparatus of claim 1, wherein said predetermined gap has a value within the range from 5 to 10 microns.

7. The apparatus of claim 5, wherein said predetermined gap has a value within the range from 5 to 10 microns.

8. The apparatus of claim 3, wherein said second annular recesses function as intermediate vacuum chambers serving for decreasing leakage of said gas into said vacuum chamber and for evacuation of said at least one sample accommodation recess prior to entering said vacuum chamber.

9. The apparatus of claim 4, wherein said second annular recesses function as intermediate vacuum chambers serving for decreasing leakage of said gas into said vacuum chamber and for evacuation of said at least one sample accommodation recess prior to entering said vacuum chamber.

10. The apparatus of claim 1, wherein a second sample accommodation recess is formed on said moveable member in a location that provides exposure of said at least one sample accommodation recess to said surrounding atmosphere when said second accommodation recess reaches said vacuum chamber, and vice verse.

11. The apparatus of claim 1, wherein said means for supplying compressed gas to said static gas bearings comprise a plurality of orifices, which are uniformly spaced from each other around said moveable member and wherein said sample accommodation recess is not aligned with said orifices.

12. The apparatus of claim 2, wherein said means for supplying compressed gas to said static gas bearings comprise a plurality of orifices, which are uniformly spaced from each other around said moveable member and wherein said sample accommodation recess is not aligned with said orifices.

13. The apparatus of claim 3, wherein said means for supplying compressed gas to said static gas bearings comprise a plurality of orifices, which are uniformly spaced from each other around said moveable member and wherein said sample accommodation recess is not aligned with said orifices.

14. The apparatus of claim 4, wherein said means for supplying compressed gas to said static gas bearings comprise a plurality of orifices, which are uniformly spaced from each other around said moveable member and wherein said sample accommodation recess is not aligned with said orifices.

15. The apparatus of claim 12, wherein said through opening has a plurality of longitudinal grooves on portion from said one side and said side opposite to said one side, respectively, and said first annular recesses, one of said,longitudinal grooves being aligned with said sample accommodation recess during said reciprocating sliding motion.

16. The apparatus of claim 14, wherein said through opening has a plurality of longitudinal grooves on portion from said one side and said side opposite to said one side, respectively, and said first annular recesses, one of said longitudinal grooves being aligned with said sample accommodation recess during said reciprocating sliding motion.

17. A method of inserting a sample into a vacuum chamber comprising the steps of:
providing an apparatus for insertion of a sample into a vacuum chamber comprising a housing located in a surrounding atmosphere, said housing having said vacuum chamber, a through opening in said housing intersecting said vacuum chamber, and a moveable member slidingly installed in said through opening in static gas bearings located on portions of said through opening beyond said vacuum chamber, said moveable member having at least one sample accommodation recess, said static gas bearings having a predetermined gap between said through opening and said moveable member, and means for supplying compressed gas into said predetermined gap;
moving said moveable member into a protruding position, in which said at least one sample accommodation recess protrudes from said housing;
placing said sample into said at least one sample accommodation recess in said protruding position;
providing said gap with a function of a seal between said static gas bearings and said vacuum chamber;
moving said moveable member along said through opening until said sample reaches said vacuum chamber;
processing said sample in said vacuum chamber;
moving said moveable member along said through opening into said protruding position; and
unloading said sample from said sample accommodation recess in said protruding position.

18. The method of claim 17, further comprising the step of providing said through opening with means for exhausting of said gas between said vacuum chamber and said static gas bearings.

19. The method of claim 17, further comprising the step of providing said through opening with intermediate vacuum chambers located between said vacuum chamber and said static gas bearings, said intermediate vacuum chambers serving for decreasing leakage of said gas into said vacuum chamber and for evacuation of said at least one sample accommodation recess prior to entering said vacuum chamber.

20. The method of claim 18, further comprising the step of providing said through opening with intermediate vacuum chambers located between said vacuum chamber and said means for exhausting of said gas, said intermediate vacuum chambers serving for decreasing leakage of said gas into said vacuum chamber and for evacuation of said at least one sample accommodation recess prior to entering said vacuum chamber.

21. The method of claim 17, further comprising the steps of:
forming a second sample accommodation recess in said moveable member for placing a second sample in a location that provides exposure of said at least one sample accommodation recess to said surrounding atmosphere when said second sample reaches said vacuum chamber; and
using said at least one sample accommodation recess and said second sample accommodation recess in an alternating sequence so that when said sample is in said vacuum chamber, said second sample can be placed into said second sample accommodation recess, and when said second sample is in said vacuum chamber, said sample can be removed from said at least one sample accommodation recess and replaced by a new sample for subsequent processing in said vacuum chamber.
